(19) United States
(12) Patent Application Publication
(10) Pub. No.: US 2017/0238039 A1
(43) Pub. Date: Aug. 17, 2017

(54) INJECTING STREAMING MEDIA INTO A PLAYLIST

(71) Applicant: InterDigital Patent Holdings, Inc., Wilmington, DE (US)

(72) Inventor: Matteo Sabattini, Wilmington, DE (US)

(73) Assignee: InterDigital Patent Holdings, Inc., Wilmington, DE (US)

(21) Appl. No.: 15/504,597

(22) PCT Filed: Aug. 18, 2015
(86) PCT No.: PCT/US2015/045710

§ 371 Date: Feb. 16, 2017

Related U.S. Application Data
(60) Provisional application No. 62/038,680, filed on Aug. 18, 2014.

(51) Int. Cl. H04N 21/262; G06Q 30/02; H04N 21/258; H04N 21/81; H04N 21/45; G06F 17/30; H04N 21/234

(52) U.S. Cl. CPC H04N 21/26258; G06F 17/30772; G06F 17/30761; G06F 17/30752; G06Q 30/0277; H04N 21/23424; H04N 21/8113; H04N 21/4532; H04N 21/25891; H04N 21/812

(57) ABSTRACT

Systems, methods, and instrumentalities are disclosed for determining that a user is playing a playlist on a wireless device, offering an insertion opportunity to a third party, receiving a request from the third party to insert a media content into the playlist, wherein the media content is not part of the playlist, and injecting the media content into the playlist without the user's intervention. Systems, methods, and instrumentalities are disclosed for receiving information about a user playing a playlist on a wireless device, determining, based on the information, a media content for the user, wherein the media content is not part of the playlist, and requesting a playlist service provider to inject the media content into the playlist, without the user's intervention.

### CROSS-REFERENCE TO RELATED APPLICATION

This application claims the benefit of U.S. Provisional Patent Application No. 61/990,655, titled “Machine Type Communications Monitoring Services”, filed May 8, 2014, the contents of which are incorporated by reference as if fully set-forth herein in their respective entirety, for all purposes.

### BACKGROUND

Several systems and software programs exist to manage and play libraries of media files, including music and videos that a user has obtained the rights to play (e.g., “user-owned” files). User-owned media files may be saved locally. User-owned files may be saved remotely (e.g., in the cloud). Examples of services to manage and play libraries of user-owned files may include Windows Media Player™, Apple iTunes™, iTunes Match™, and Google Play™.

Other services allow users to stream music or consume online media content, but without ownership. Other services allow users to stream music or consume online media content, but without allowing a copy (e.g., an unprotected (e.g., not in DRM-locked format) copy) of the content to be saved or stored for playback. Such services may be streaming services. Some streaming services let a user define his/her tastes and then the streaming service builds a real-time streaming session based on the tastes (e.g., “personalized” streaming services). Examples of personalized streaming service providers include services like Pandora™ or Spotify™, which may create a personalized radio for the user by updating the selection based on user feedback.

It would be desirable for the above-mentioned services (e.g., services to manage and play libraries of user-owned files and personalized streaming service providers) to intercommunicate, and share information about the user's preferences and tastes. This may lead to a better experience for the user, such as by expanding the user's knowledge and appreciation. It would be desirable to develop techniques to allow services to push media content based on the user's preferences, characteristics, or media across different services to make a user aware of such media content.

### SUMMARY

Systems, methods, and instrumentalities are disclosed for determining that a user is playing a playlist on a wireless device, offering an insertion opportunity to a third party, receiving a request from the third party to insert a media content into the playlist, wherein the media content is not part of the playlist, and injecting the media content into the playlist without the user's intervention.

Systems, methods, and instrumentalities are disclosed for receiving information about a user playing a playlist on a wireless device, determining, based on the information, a media content for the user, wherein the media content is not part of the playlist, and requesting a playlist service provider to inject the media content into the playlist, without the user's intervention, the streaming media content being selected based on the user's tastes, preferences, context, and/or content of the playlist.

### BRIEF DESCRIPTION OF THE DRAWINGS

FIG. 1 is a diagram of an example of injecting a recommended song into a user's playlist.

FIG. 2 is a diagram of an example of obtaining and playing a recommended song.

FIG. 3 is a diagram of an example of a call flow for determining user preferences and playing a recommended song.

FIG. 4 is a diagram of an example of a call flow for determining user preferences and playing a recommended song.

FIG. 5 is a diagram of an example of a call flow for determining user preferences and playing a recommended song.

FIG. 6 is a diagram of an example of a system in which a third party recommender may push a recommendation into a play queue and/or a playlist based on a bi-directional Application Programming Interface (API).

FIG. 7 is a diagram of an example of a call flow by which a third party recommender may push a recommendation into a play queue and/or a playlist based on a bi-directional API.

FIG. 8 is a diagram of an example of a system in which a third party recommender may push a recommendation into a play queue and/or a playlist based on a bi-directional API.

FIG. 9 is a diagram of an example of a call flow by which a third party recommender may push a recommendation into a play queue and/or a playlist via a service provider using a bi-directional API.

FIG. 10A-C is a diagram of an example of a user interface which may allow a user to access a push recommendation.

FIG. 11 is a diagram of an example of API calls and responses for playing a recommended song.

FIG. 12 is a diagram of an example of a request to determine the most recent songs played.

FIG. 13 is a diagram of an example of a table built while determining user preferences.

FIG. 14 is a system diagram of an example communications system in which one or more disclosed embodiments may be implemented.

FIG. 15 is a system diagram of an example wireless transmit/receive unit (WTRU) that may be used within the communications system illustrated in FIG. 14.

### DETAILED DESCRIPTION

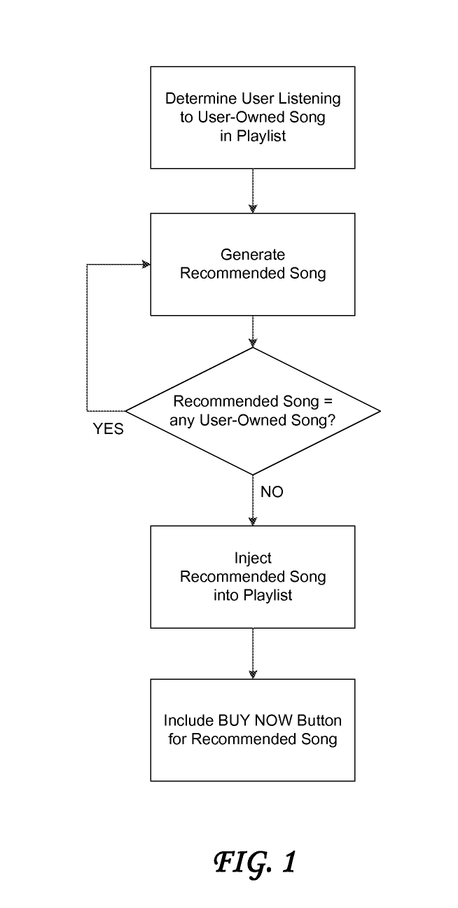

FIG. 1 is a diagram illustrating an example of a process for injecting a recommended song into a user's playlist. A user may be listening to a user-owned song. A user-owned song may be a media file, such as music or video, that a user owns or has obtained the rights to play (e.g., playback rights). For example, the user may have the user-owned song stored as an unprotected music file on a device of the user, or the user may have a right to retrieve such an unprotected music file from a “cloud locker” of the user. The user-owned song may be in a playlist. The playlist may be a play queue. The playlist may be a list of songs to play, such as a list that the user has created. The playlist may be a persistent playlist, that is it may be a fixed list of songs associated with a playlist name, wherein the user may select the playlist name in order to begin playback of the songs of the fixed list. The user may have assigned the playlist name at the time the user created and/or saved the persistent playlist.

A party other than the user, for example, a service provider, may wish to determine that a user is listening to a user-owned song in a playlist. The service provider may be a service provider of services to manage and play libraries of user-owned files (such as, Windows Media Player™, Apple iTunes™, iTunes Match™, and Google Play™, for example). The service provider may be a personalized streaming service provider (such as Pandora™ or Spotify™, for example). Personalized streaming service providers take a user's tastes into account in order to provide a customized experience. Personalized streaming service providers may not include streaming service providers who stream media content based on considerations other than the preferences of a given user (such as, specific demographics (e.g., sports channels, pop stations, country stations), for example).

The service provider may generate a recommended song. A song may be recommended based on a number of considerations. The song may be selected based on the media content currently being consumed (e.g., observations of user-owned song plays). The song may be selected based on the media content in the user's user-owned library (e.g., specific artists). The song may be selected based on the media content representing the user's streaming tastes (e.g., certain genres at certain times). The song may be selected based on the media content representing the user's preferences (e.g., blocked artist or favorite artists). The song may be selected based on the context of the user preferences (e.g., live concert collections, certain eras, certain sub-genres).

In some examples, the user-owned library may be analyzed in order to recommend a song (e.g., a song that the user would be likely to enjoy). The service provider may analyze the user's user-owned library and/or song plays in real time. The service provider may analyze the user's user-owned library and/or song plays through metadata analysis and/or spectrum signature matching (similar to that provided by Shazam's identification techniques) in real time. The service provider may analyze the user's user-owned library and/or song plays offline (i.e., not at playtime).

Once a song recommendation is generated, the service provider may check to determine if the recommended song is in the user-owned library. If the recommended song is already in the user-owned library, then the methods are repeated and a new song is recommended. If the recommended song is not already in the user-owned library, then the service provider may inject the recommended song into the playlist. The recommended song may be a streaming version of the recommended song. The service provider may inject the recommended song into the playlist, for example, between two user-owned songs in the playlist. The recommended song may then be played in sequence with the other songs in the playlist. In the case of a persistent playlist, the recommended song may be injected into a current playback experience (e.g., a play queue generated when the user selects the persistent playlist for playback). Alternately the recommended song may be injected into the persistent playlist object itself. In the latter case, the recommended song may be included in sequence with the other songs of the persistent playlist when the user selects the persistent playlist for playback at a later time, or when the user shares the persistent playlist with other users.

The service provider may give the user additional information about the recommended song. The service provider may give the user the opportunity to purchase the recommended song. The service provider may give the user the opportunity to purchase the whole album containing the recommended song. The service provider may give the user the opportunity to purchase a “best of” the artist compilation containing the recommended song. The opportunity to purchase may be concurrent during the song playback. For example, a “BUY NOW” button may be presented to the user. The opportunity to purchase may be concurrent during the song playback. For example, an email may be sent to the user later with a list of songs that were injected during playtime.

In the case of a persistent playlist object, the additional information about the recommended song may be stored as metadata in a playlist file which defines the persistent playlist object. Such stored information may include an indication that the recommended song is not a user-owned song. Such stored information may include an indication that a music player application should display a BUY NOW button when the recommended song is played during future playback of the persistent playlist object. Such stored information may include a link to a location (e.g., a website or other internet location) where the user may purchase the recommended song or a related album.

Users may benefit from real-time, automatic recommendations based on what the user is listening to in one domain (user-owned or streaming) from another domain. The recommended media content may be offered for sale to the user if it is not yet owned by the user. As an example, suppose a user is listening to user-owned music by a certain group (for example, The Rolling Stones®) in a playlist. It may be likely that the user would enjoy bands that are similar to the certain group (for example, similar bands to The Rolling Stones®, such as The Doors®). The service provider may analyze the user's user-owned library and/or song plays in real time. The service provider may analyze the user's user-owned library and/or song plays through metadata analysis and/or spectrum signature matching (similar to that provided by Shazam®'s identification techniques) in real time. The service provider may analyze the user's user-owned library and/or song plays offline (i.e., not at playtime).

Automatic recommendations and/or song injections may be performed when a user is not actively playing a playlist. For example, a user's persistent playlists may be analyzed in order to generate song recommendations, and the playlist file which defines the persistent playlist object may be modified to insert recommended songs. An analysis engine may process a user's collection of persistent playlists to analyze the included songs and generate/insert recommended songs, whether or not the user is actively listening to music. For example, a recommended streaming song (e.g., a song that the user does not own) may be inserted into a persistent playlist of a user based on other songs (e.g., user-owned songs) already included in the persistent playlist. The playlist file that defines the persistent playlist may be modified as a result. At a later time, the user may discover the recommended streaming song when the user selects the persistent playlist for playback, or another user may discover the recommended streaming song within the persistent playlist as a result of the persistent playlist being shared to that other user. The analysis engine which performs such analysis and insertion operations may be located within a music player application on a user's device, on a server associated with a music service, or any location which has access to a persistent playlist object (e.g., a playlist file). When a persistent playlist file is shared to other users, the analysis and insertion operation may be carried out in transit, e.g., by an analysis engine which has access to the persistent playlist object en route to the other users, or by an analysis engine present within a music player application on a device of one of the target users to whom the persistent playlist has been shared.

The service provider may determine that the user may enjoy a similar band. Upon analysis of the user's user-owned library, the service provider may determine that the user does not own any songs (or does not own a specific song) by the similar band (e.g., The Doors®). The service provider may inject a streaming song by the similar band, for example, between two user-owned songs in the playlist. The user may experience an improved user experience.

A method to inject (e.g., automatically inject) recommended streaming media content into a user-owned playlist is provided. The recommended streaming media content may be selected based on the media content currently being consumed (e.g., observations of user-owned song plays). The recommended streaming media content may be selected based on the media content in the user's user-owned library (e.g., specific artists). The recommended streaming media content may be selected based on the media content representing the user's streaming tastes (e.g., certain genres at certain times). The recommended streaming media content may be selected based on the media content representing the user's preferences (e.g., blocked artist or favorite artists). The recommended streaming media content may be selected based on the context of the user preferences (e.g., live concert collections, certain eras, certain sub-genres). A user may be given the option to purchase the recommended streaming media content. The user's decision to purchase (or decision not to purchase) may be used to further refine the estimation of the user's tastes and provide more accurate recommended content selection.

The foregoing intercommunication between personalized streaming services and user-owned services may employ bi-directional Application Programming Interfaces (APIs). The APIs may be unified, inter-service communication APIs (provided, for example, at the OS level of a mobile device). The APIs may be proprietary APIs controlled and managed by the service providers themselves.

The APIs may allow different service providers to gather information about the user (such as the user's tastes, history, experience, and current music being played from other services, for example), and use the information to tailor recommendations and suggested content. Privacy settings may allow the user to customize what information is available (or to which service provider) or to turn off the feature. For example, the user may be listening to music using a primary service provider to which the user has access. The term “primary” is used to describe the music service that the user is directly using to listen to the music currently (if a user switches playback services, the new service becomes the primary service provider). The user may be using a music player application of the primary service provider, or may be listening via a web site associated with the primary service provider. The APIs may allow other service providers to communicate with the primary service provider in order to push media content into the user's play queue or playlist (e.g., a currently playing playlist) or to instruct the primary service provider to play a specific media file.

Information about media content and preferences may be exchanged through the exchange of metadata, and based on standard or proprietary interfaces. The APIs may let other service providers access the metadata associated with the media content consumed by the user, a subset of the metadata, or the full details of the user's media library or playlist(s). For example, metadata relating to audio content (for example, songs) may be based on the proprietary Apple iTunes™ metadata format, the standard ID3 format, or any suitable format. Similarly, the APIs may provide information about the user's interaction with media content, including “likes,” “skips,” play-count indices, etc. Information about user's preferences and tastes may be exchanged, for example, as musical characteristics (“genes”) as defined by the Music Genome Project.

Specific estimates of the user's tastes may be returned when queried. For example, the APIs may allow a third-party service provider to provide a proposed recommended content, and the service provider (e.g., the primary service provider) may respond with a likelihood of the user liking the proposed recommended content. For example, the likelihood may be a percentage value or a number between 0 and 1.

The APIs may allow a personalized streaming service provider to push media content to a service provider of user-owned files or vice versa. The APIs may allow a personalized streaming service provider to inject media content to a playlist of a user (e.g., a playlist supported by a service provider of user-owned files). The primary service provider and/or the playlist may provide access to user-owned files.

Selection of the recommended song may be based on a number of factors. The recommended song may be a song the user does not own. The recommended song may be a song that only the personalized streaming service provider has the rights to stream and/or sell the rights to. The recommended song may be a song by a local band not yet available on the service provider. The recommended song may be a live version of a song the user already owns.

Associated services may be offered with the recommended song (e.g., either paired with purchase of the song or to be purchased by themselves). For example, tickets to a local concert or show by the artist may be offered. The option to purchase tickets to a movie including the song in the soundtrack may be given to the user. Discounts for local venues specializing in the same genre or sub-genre as the recommended song may be offered. Similarly, associated services may be provided by those more broadly related to the media/music industry, including events tickets providers, local venues, garage and underground bands, movie theaters and distributors, record labels, advertisers, etc. These providers may desire that information be pushed to the user about local events, promotions, and any other offer that broadly relates to the user's taste, history, or current playlist, as an associated service.

In one example of an associated service, a venue ticket provider (such as Ticketmaster™, for example) may push to a primary service provider (i.e., a service provider of user-owned files (such as iTunes™, for example) or a personalized streaming service provider) a live version of a song the user owns (e.g., where the live version is different than the version of the song owned by the user). The venue ticket provider may provide additional metadata noting the fact that the artist will be playing live in a venue located in the user's proximity in the near future. The additional metadata may contain a link to an offer to purchase tickets. As a result, the live version of the song may be inserted into the user's play queue or into a playlist of the user, while the user is listening to music using the primary service provider. The primary service provider may use the additional metadata to offer the user an option to purchase tickets to the show while listening to the injected song. The primary service provider (e.g. Apple™) may charge the venue ticket provider (e.g. Ticketmaster™) a percentage of the purchase price for the information about and/or the connection to the user it provides.

In an example of an associated service, a movie ticket reseller (such as Fandango™ for example), may push to a primary service provider (such as iTunes™, for example) a song the user might be interested in, if the song happens to be in the soundtrack of a recently released movie. As before, additional metadata containing information about the movie and a link to an offer related to the movie may be provided. The song may be inserted into the user's play queue or into a playlist of the user, while the user is listening to music using the primary service provider. The primary service provider may use the additional metadata to offer the user an option to purchase tickets to the movie at a theater located in the user's proximity, and the presentation of such option may be triggered by the playout of the song. For example, the primary service provider (e.g., Apple®) may charge the movie ticket reseller a fee (e.g., a percentage of the purchase price) in exchange for connecting the user to the movie ticket reseller.

In another example of an associated service, a service that promotes local or little-known bands may push to a service provider of user-owned files (such as iTunes™, for example) a song the user might be interested in. For example, songs by local artists not yet on iTunes™ may be pushed to the user's playlist on iTunes™ based on his/her preferences across services. Songs may be promotionally offered for free to the user to improve popularity of an associated music label or band. For example, the service provider (e.g., Apple®) may secure an option to sell (e.g., exclusively sell) music by those bands that gain enough traction through introduction to users via the primary music service. The promotional service may get a percentage of the sales.

In an example of an associated service, a record label may test marketability of artists, bands, or songs by using the API to push song recommendations to users via the primary service provider. Artists who reach a predetermined popularity may be given the opportunity to sign contracts with the record labels.

In an example of an associated service, a service that promotes local venues may push footage or music of a recent concert to the user's play queue or into a playlist of the user via the primary service provider. Additional promotional offers, like discounts or coupons, may be offered in association with playout of the pushed content.

The user may have full privacy control of what is shared through the APIs. For example, the user may be given tools to determine how much information, if any, may be shared and with which service(s), such as through a settings page or a console. For example, the user may turn on and off sharing altogether. The user may hide personal information, like demographics, to all services. The user may allow personalized streaming services to access the metadata and play counts associated with the user-owned library. The user may allow the service provider for the user-owned library to access data (e.g., metadata, playlists, radio stations, etc.) collected by personalized streaming services.

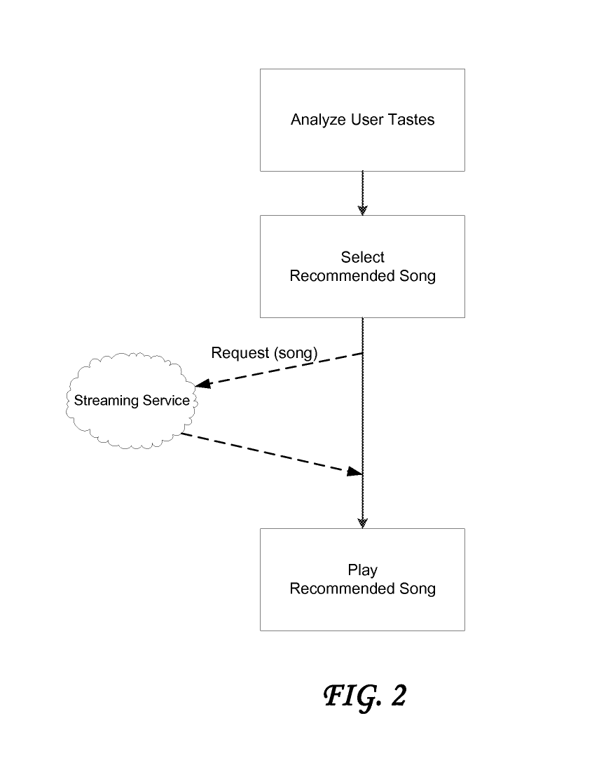

FIG. 2 is a diagram illustrating an example of a process for playing a recommended song (e.g., one that is not user-owned). A service provider for the user-owned library may select a song, not currently in the user's user-owned library, based on the user's playlist (for example based on, and not limited to, most played songs, songs currently played, play counts, etc.). A recommended song is selected by the service provider for the user-owned library. The service provider for the user-owned library may seek for the recommended song. The recommended song may be received and played from any streaming service, including the service provider for the user-owned library's cloud repository. The recommended song may be selected and injected (e.g., automatically selected and injected) into the playlist without the user's intervention.

The user may be given the opportunity to interact with the service provider regarding the recommended song, for example “liking” the song or making a purchase (e.g., the song, the album, the artist's catalog, etc.). Furthermore, the user may be given the option to purchase the entire album the song belong to, the whole discography of the artist playing the song, and/or all missing (from the user-owned library) songs by the artist.

Information about user's interaction with the streaming song (e.g., “did the user like the song?” “did the user actually make a purchase?” etc.) may be fed back to the recommendation engine to provide refined suggestions going forward. For example, if the user does not purchase songs by a specific artist more than once, the artist may not be suggested in the future.

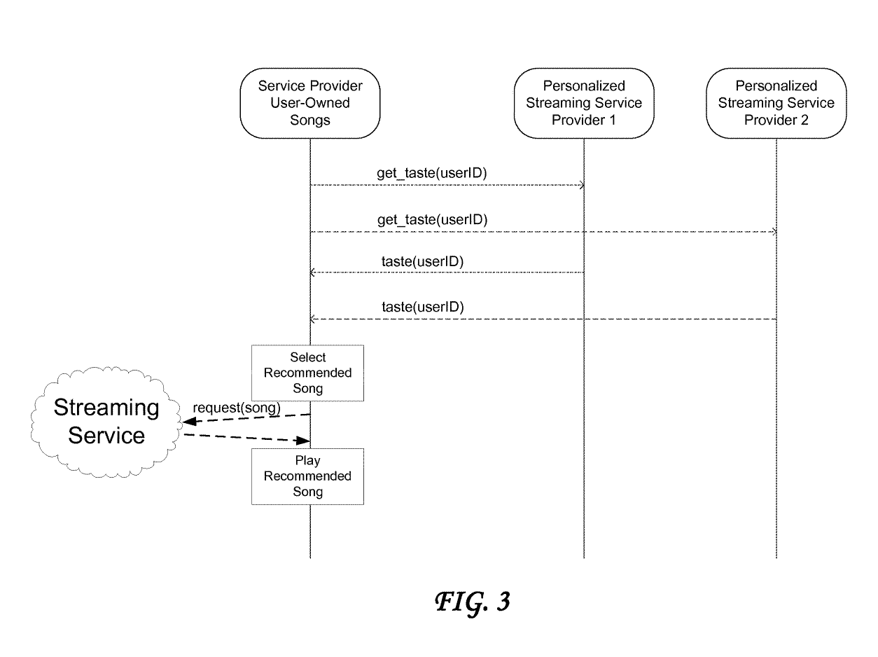

FIG. 3 is a diagram of an example of a call flow for determining user preferences and playing a recommended song. A service provider for user-owned songs (such as iTunes™) may gather information about the user's tastes and preferences from personalized streaming service providers (such as Pandora™ and/or Spotify™). The service provider for user-owned songs may be acting as a primary service provider, that is it may be the service provider to which the user is currently listening. The services may exchange messages about the user's taste through message exchange via a bi-directional API. Upon receiving the taste information, the service provider for user-owned songs may select a recommended song. The taste information may refine the selection of the recommended song. The recommended song may be selected and injected into the user's play queue or playlist without the user's intervention (i.e., automatically selected and injected). The recommended song may be received and played from any streaming service, i.e., service provider 1, service provider 2, the service provider for the user-owned library's cloud repository, or another. The recommended song may be played.

The user may be given the opportunity to interact with the service provider regarding the recommended song, for example “liking” the song or making a purchase (e.g., the song, the album, the artist's catalog, all missing (from the user-owned library) songs by the artist, etc.). Information about user's interaction with the streaming song (e.g., did the user like the song? did the user actually make a purchase?) may be fed back to the recommendation engine to provide refined suggestions going forward. For example, if the user does not purchase songs by a specific artist more than once, the artist may not be suggested in the future.

The user may be given full control to authorize information sharing across services, for example by explicitly authorizing login information across platforms. The API may then provide standard queries where information about the user (based, for example, on user ID) is exchanged across platforms.

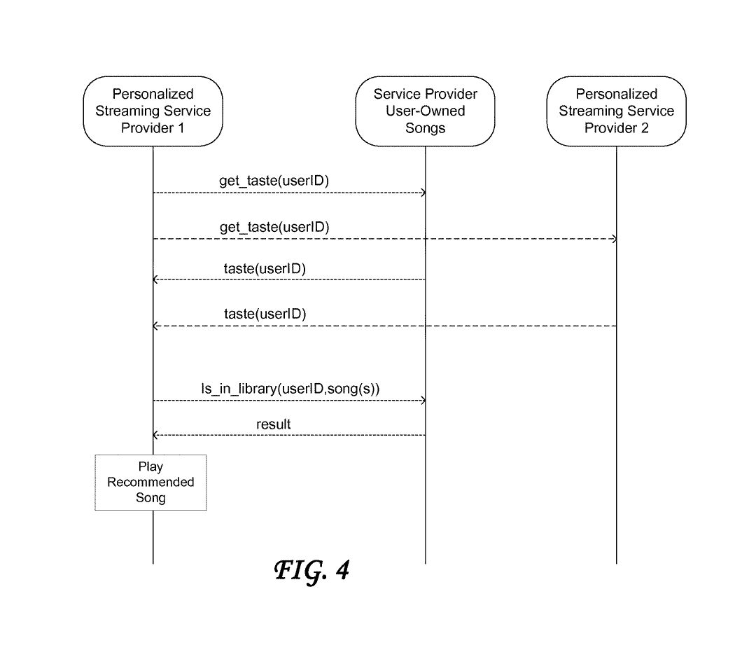

FIG. 4 is a diagram of an example of a call flow for determining user preferences and playing a recommended song. A personalized streaming service provider (such as Spotify™, for example) may gather information about the user's tastes and preferences from one or more service providers, such as a service provider for user-owned songs (such as iTunes™) and another personalized streaming service provider (such as Pandora™). The services may exchange messages about the user's taste through message exchange via a bi-directional API.

The personalized streaming service provider may select a recommended song. A specific API request may be used to query the service provider for user-owned songs about the ownership rights of the recommended song as related to the user (e.g., does the user already own the recommended song?). Based on the result received from the service provider for the user-owned songs, a song that the user does not own is selected and streamed.

The recommended song may be selected and injected into the playlist without the user's intervention (i.e., automatically selected). The recommended song may be received and played from any streaming service, including the service provider for the user-owned library's cloud repository. The recommended song may be played.

The user may be given the opportunity to interact with the service provider regarding the recommended song, for example “liking” the song or making a purchase (e.g., the song, the album, the artist's catalog, all missing (from the user-owned library) songs by the artist, etc.). Information about user's interaction with the streaming song (e.g., did the user like the song? did the user actually make a purchase?) may be fed back to the recommendation engine to provide refined suggestions going forward. For example, if the user does not purchase songs by a specific artist more than once, the artist may not be suggested in the future.

The user may be given full control to authorize information sharing across services, for example by explicitly authorizing login information across platforms. The API may then provide standard queries where information about the user (based, for example, on user ID) are exchanged across platforms.

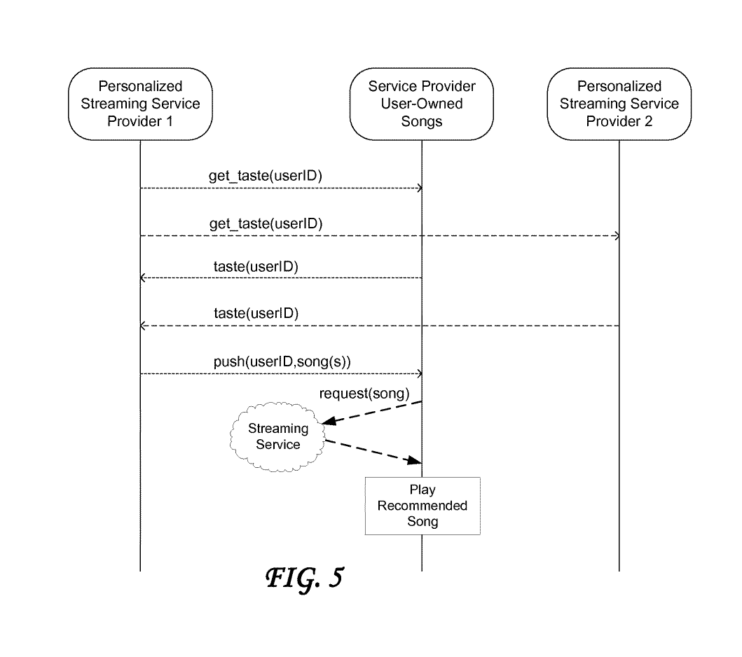

FIG. 5 is a diagram of an example of a call flow for determining user preferences and playing a recommended song. A first personalized streaming service provider (such as Spotify™, for example) may gather information about the user's tastes and preferences from one or more service providers, for example, a service provider for user-owned songs (such as iTunes™) and a second personalized streaming service provider (such as Pandora™). For example, the service provider for user owned songs may operate a cloud locker service which stores the songs owned by the user. The services may exchange messages about the user's taste through message exchange via a bi-directional API.

The personalized streaming service provider may select a recommended song. A push of media content from an outside service may be achieved with the POST call, where a streaming address is passed to the current service the user is playing content from (“current service” or primary service provider). The current service may (e.g. in response to the push recommendation) retrieve the content and inject it into the user's playlist automatically and without the user's intervention.

Metadata specifying the content to be injected may be pushed from another service provider to the current service. The current service may retrieve the content either locally or from other streaming services and inject it into the user's play queue or playlist.

The push recommendation may originate from, and/or may be for, associated services, such as described above (for example, more broadly related to the media/music industry, including events tickets providers, local venues, garage and underground bands, movie theaters and distributors, record labels, advertisers, etc.). The role of ‘Personalized Streaming Service Provider 1’ of FIG. 5 may be replaced by any of these types of entities, some of which may not operate a personalized streaming music service. Any of these listed entities may utilize the described API in order to obtain information about the user from a service provider (e.g. from the primary service provider, a service provider of user-owned songs, and/or a personalized streaming service provider), and may further utilize the described API to push a song recommendation to a service provider (e.g. to the primary service provider).

The recommended song service provider may query the user-owned media files library services provider to determine whether the recommended song is owned by the user, and the user-owned library services provider may return a result. Based on the result received from the service provider for the user-owned songs, a song that the user does not own may be selected and streamed. The recommended song may be selected and injected into the playlist without the user's intervention (i.e., automatically selected and injected). The recommended song (and media content) may be received and played from any streaming service, including the service provider for the user-owned library's cloud repository. The recommended song (and media content) may be played.

The user may be given the opportunity to interact with the recommended song provider, for example “liking” the song or making a purchase (for example, related to the media content). Information about user's interaction with the streaming song (e.g., did the user like the song? did the user actually make a purchase related to the media content?) may be fed back to the recommendation engine to provide refined suggestions going forward. For example, if the user does not purchase songs by a specific associated service more than once, the associated service may not be suggested in the future.

The user may be given full control to authorize information sharing across services, for example by explicitly authorizing login information across platforms. The API may then provide standard queries where information about the user (based, for example, on user ID) are exchanged across platforms.

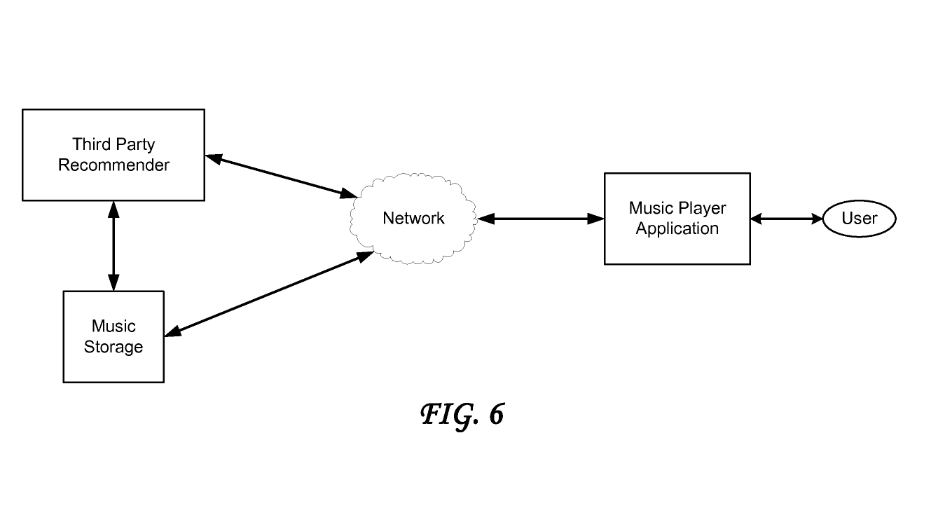

FIG. 6 shows an example system in which a third party recommender may push a recommendation into a play queue and/or a playlist based on a bi-directional API. As shown in the figure, a user may utilize a music player application to access and listen to music. The music player application may run on a device of the user. For example, the music player application may be an application running on a mobile device, a software program running on a personal computer, or a web application accessible in a web browser. The music player application may be associated with a service provider (e.g., a primary service provider to which the user has access). The music player application may provide access to user-owned songs, streaming songs, or both types of songs. The third party recommender may have additional music not accessible to the user via the primary service provider or the music player application. The additional music may be stored in a storage device (e.g., an HTTP server) accessible to the third party recommender. The storage device may be accessible to the music player application via a network. The third party recommender may be, for example, an event ticket seller, a movie studio or distributor, a local music club, a music label, a representative of one or more musical artists or musical groups, an advertiser, etc.

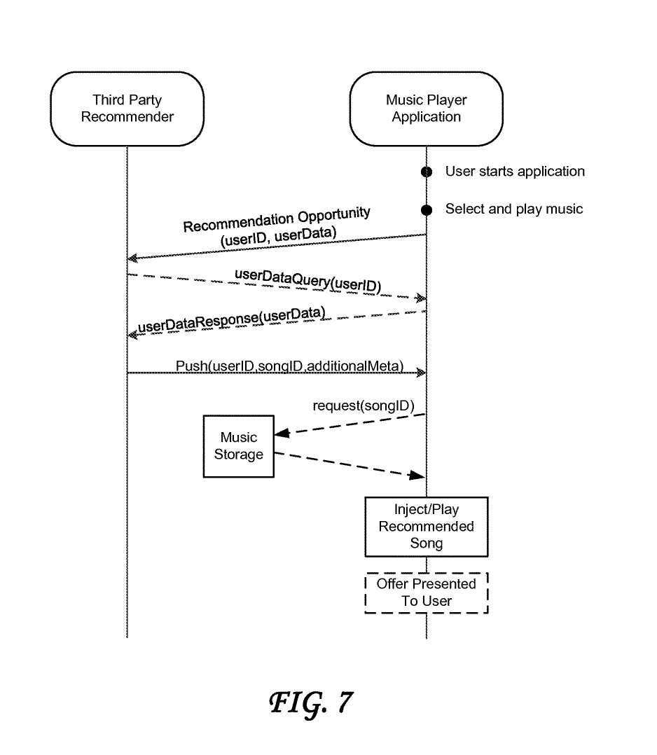

FIG. 7 shows an example call flow by which a third party recommender may push a recommendation into a play queue and/or a playlist based on a bi-directional API. The call flow may be performed by the entities of FIG. 6. As shown in FIG. 7, the user may start the music player application and may select and play music. The selected music may include user-owned music. If the music player application is associated with a streaming service, the selected music may include streaming music which the user does not own. The music player application may connect to a service provider (e.g., the primary service provider) as needed to allow the user to select and play music.

The music player application may send a message via the API to a third party recommender which indicates a recommendation opportunity. This recommendation opportunity may serve to invite the third party recommender to create a push recommendation suitable for the user of the music player application. The recommendation opportunity may identify the user (userID), and may include data about the user (userData). The userData may include, for example, user preferences, user demographic information, favorite artists of the user, favorite genres, a list of recently played songs, an indication of a currently played song, an indication of songs currently in the user's play queue or in a playlist of the user, etc. The userData may include incomplete information about the user, or it may be absent from the recommendation opportunity message.

The third party recommender may use the API to query the music player application for additional information about the user. The query interaction may contain specific queries to obtain information about the user according to the various types of userData introduced above. For example, one third party recommender may be interested in the user's favorite artists, and the current contents of a user's play queue. The third party recommender may interrogate the music player application using one or more query message exchanges in order to obtain the information about the user which the third party recommender would use to select a recommended song for the user.

The third party recommender may use the information about the user (the various types of userData obtained in the recommendation opportunity message and/or the user data query exchanges) in order to select a recommended song to inject into the user's play queue and/or into a playlist of the user. The third party recommender may send a push recommendation message to the music player application to identify the song to be injected. The message may identify the user (userID), may identify the song (songID), and may include additional metadata which describes an offer or an advertisement which corresponds to the recommended song. A description of the song (e.g., song title, artist, album art, etc.) may be included in the push recommendation message, or such information may be retrievable by the music player application using the songID. The songID may be, for example, an HTTP url which identifies the location where the song may be retrieved from the storage device (e.g., an HTTP server). Alternately, the songID may be a unique identifier which identifies the song (or a music file containing the song) in a song identifier namespace. The additional metadata may include text, graphics, imagery, and/or links associated with an offer or an advertisement which corresponds to the recommended song.

The music player application may insert the recommended song into the user's play queue or into a playlist of the user. The user may use the play queue and/or the playlist to listen to the recommended song. When the music player application is playing the recommended song, it may concurrently display the offer or advertisement. The user may invoke an active link in the displayed offer or advertisement in order to make a purchase or take advantage of a special offer which relates to the recommended song.

The music player application or a service provider associated with the music player application (e.g., the primary service provider) may retrieve the recommended song from the third party recommender in order to play the recommended song for the user. The song may be retrieved in real time (e.g., streamed from the storage device of the third party recommender). Alternately the service provider or the music player application may retrieve the song in advance so that the song is available for playback. If a third party recommender intends to use a song many times in the push recommendation process, then the third party recommender may use a song ingestion API to add the song to the service provider's song library. Once this is done, the third party recommender may in the future recommend the song by referencing the songID which the service provider assigned to the song at the time the service provider ingested the song from the third party recommender. In this way, multiple transfers of the song from the third party recommender to the service provider may be avoided.

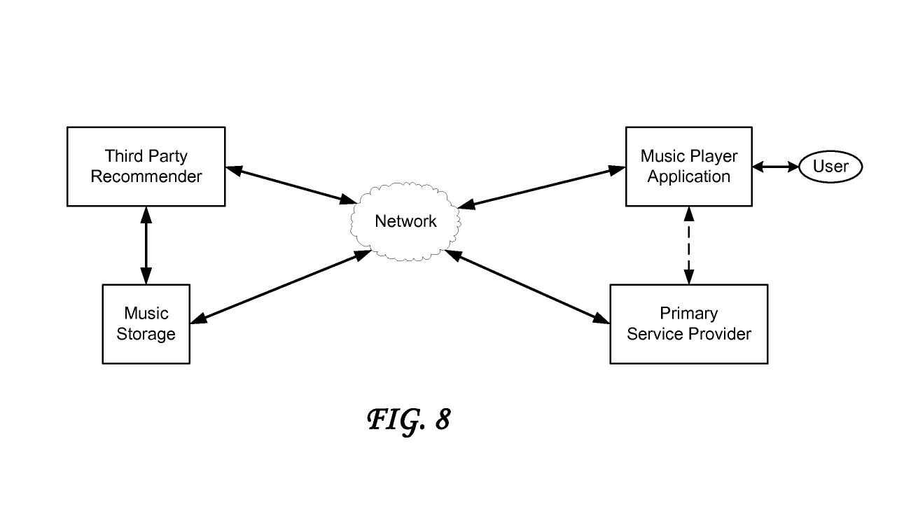

FIG. 8 shows an example system in which a third party recommender may push a recommendation into a play queue and/or a playlist based on a bi-directional API. A user may utilize a music player application (e.g., running on a device of the user) to access and listen to music. The music player application may be, for example, an application running on a mobile device, a software program running on a personal computer, or a web application accessible in a web browser. The music player application may be associated with a service provider such as a primary service provider. The music player application may connect to and/or communicate with the service provider in order to provide the user with access to music. Such connection may be over a network. The music player application may provide access to user-owned songs, streaming songs, or both types of songs.

The music player application and or the service provider may communicate with a third party recommender via a network. The third party recommender may have additional music not accessible to the user via the service provider or the music player application. The additional music may be stored in a storage device (e.g., an HTTP server) accessible to the third party recommender. The storage device may be accessible to the service provider via a network. The third party recommender may be, for example, an event ticket seller, a movie studio or distributor, a local music club, a music label, a representative of one or more musical artists or musical groups, an advertiser, etc.

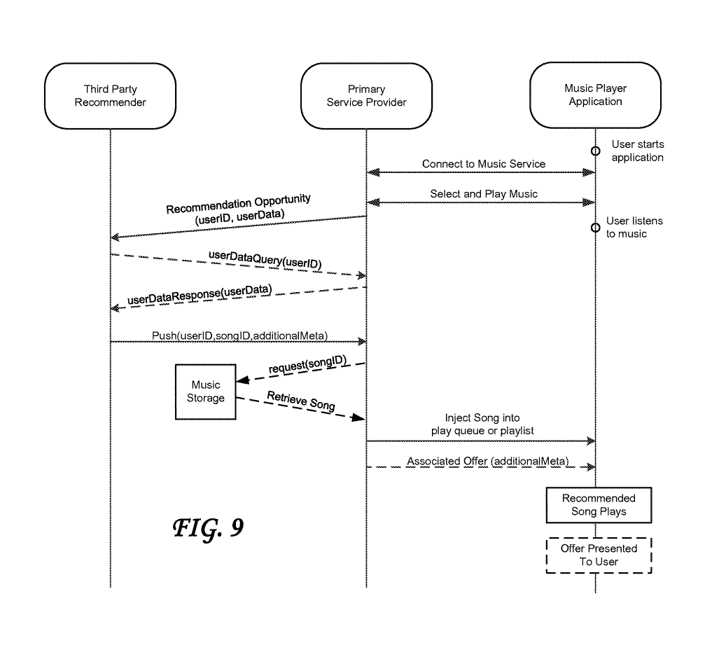

FIG. 9 shows an example call flow by which a third party recommender may push a recommendation into a play queue and/or a playlist via a service provider using a bi-directional API. The call flow may be performed by the entities of FIG. 8. As shown in FIG. 9, the user may start the music player application in order to select and play music. The music player application may connect to the service provider to obtain access to the music service. Such initial connection may require credentials (e.g., a username and password) in order to connect to the music service. Using the connection, the music player application may allow the user to select and play music. The selected music may include user-owned music, whether available locally on the user device, or streamed from the music service (e.g., from a cloud locker of the user). The selected music may include streaming music which the user does not own, for example such music may be available from the music service via a subscription of the user. The service provider may stream music to the music player application via a network.

The service provider may send a message via the API to a third party recommender which indicates a recommendation opportunity. This recommendation opportunity may serve to invite the third party recommender to create a push recommendation suitable for the user of the music player application and/or the music service. The recommendation opportunity may identify the user (userID), and may include data about the user (userData). The userData may include, for example, user preferences, user demographic information, favorite artists of the user, favorite genres, a list of recently played songs, an indication of a currently played song, an indication of songs currently in the user's play queue or in a playlist of the user, etc. The userData may include incomplete information about the user, or it may be absent from the recommendation opportunity message.

The third party recommender may use the API to query the service provider for additional information about the user. This interaction may contain specific queries to obtain information about the user according to the various types of userData introduced above. For example, a third party recommender may be interested in the user's favorite genres, the user's age, and the song that the user is currently listening to. The third party recommender may interrogate the service provider using one or more query message exchanges in order to obtain the information about the user which the third party recommender would use to select a recommended song for the user.

The third party recommender may use the information about the user (the various types of userData obtained in the recommendation opportunity message and/or the user data query exchanges) in order to select a recommended song to inject into the user's play queue and/or into a playlist of the user. The third party recommender may send a push recommendation message to the service provider to identify the song to be injected. The message may identify the user (userID), may identify the recommended song (songID), and may include additional metadata which describes an offer or an advertisement which corresponds to the recommended song. A description of the song (e.g., song title, artist, album art, etc.) may be included in the push recommendation message, or such information may be retrievable by the service provider and/or the music player application using the songID. The songID may be, for example, an HTTP url which identifies the location where the song may be retrieved from the storage device (e.g., an HTTP server). Alternately, the songID may be a unique identifier which identifies the song (or a music file containing the song) in a song identifier namespace. The additional metadata may include text, graphics, imagery, and/or links associated with an offer or an advertisement which corresponds to the recommended song.

The service provider may communicate with the music player application to insert the recommended song into the user's play queue or into a playlist of the user. The service provider may communicate the additional metadata or the associated offer described by the additional metadata to the music player application. The communication may associate the recommended song with the additional metadata or the associated offer. The user may use the play queue and/or the playlist to listen to the recommended song. When the music player application is playing the recommended song, it may concurrently display the offer or advertisement. The offer or advertisement may include an active link, and the user may invoke the active link in the displayed offer or advertisement in order to make a purchase or take advantage of a special offer which relates to the recommended song.

The music player application or a service provider may retrieve the recommended song from the third party recommender in order to play the recommended song for the user. The song may be retrieved in real time (e.g., streamed from the storage device of the third party recommender). Alternately the service provider or the music player application may retrieve the song in advance so that the song is available for playback. If a third party recommender intends to use a song many times in the push recommendation process, then the third party recommender may use a song ingestion API to add the song to the service provider's song library. Once this is done, the third party recommender may in the future recommend the song by referencing the songID which the service provider assigned to the song at the time the service provider ingested the song from the third party recommender. In this way, multiple transfers of the song from the third party recommender to the service provider may be avoided. Similarly, if the third party recommender intends to use the offer or advertisement described by the additional metadata multiple times, then the third party recommender may ingest the offer or advertisement into the service provider, and may subsequently provide the additional metadata by referencing an identifier (e.g., a unique identifier) associated with the additional metadata.

In an embodiment, the service provider may aggregate multiple recommendation opportunities across multiple users into a single message sent to the third party recommender. These may reflect multiple users who are concurrently accessing the music service from multiple different user devices. For example, a recommendation opportunity message may include multiple sets of userIDs and multiple sets of userData. In this case, the third party recommender may proceed to interrogate the service provider about the multiple users, and may then generate multiple push recommendations corresponding to some or all of the multiple users identified in the recommendation opportunity message.

In an embodiment, the user data query API which provides user information may obfuscate user-identifiable information from the query responses in order to hide the user's true identity from the third party recommender. For example, information such as the user's name and location may be withheld, and the userID may be an anonymous userID which is valid only for the duration of a recommendation session. That is, the same user may be assigned a different userID at a later point in time, such that third party recommender may not aggregate information about a particular user which it learns over multiple sessions or over an extended period of time.

In an embodiment, the push recommendation may be carried out using a playlist which the user may not be actively using. For example, the service provider and/or the music player application may invite a third party recommender to generate a push recommendation to be inserted into one of the user's playlists (e.g., a persistent playlist of the user) during a period where the user is not using the persistent playlist. This may occur during a time when the user is not actively using the music service, or is not running the music player application. Via the bi-directional API, the service provider may send a recommendation opportunity message to the third party recommender, and the third party recommender may obtain information about the user via the user data query exchange as previously described. The service provider may provide information about the user's playlist (e.g., the list of songs included in a particular playlist of the user), and the third party recommender may generate a push recommendation in order to inject a song into the user's playlist. The push recommendation may include additional metadata describing an offer or advertisement as described previously. The service provider and/or the music player application may store the additional metadata in order to display the offer or advertisement at a later time when the user accesses the playlist and uses it to play the recommended song injected into the playlist. The additional metadata may be stored in association with the recommended song or in association with the playlist. The additional metadata may be stored as side data within the playlist object itself (e.g., within a file which defines a persistent playlist of the user).

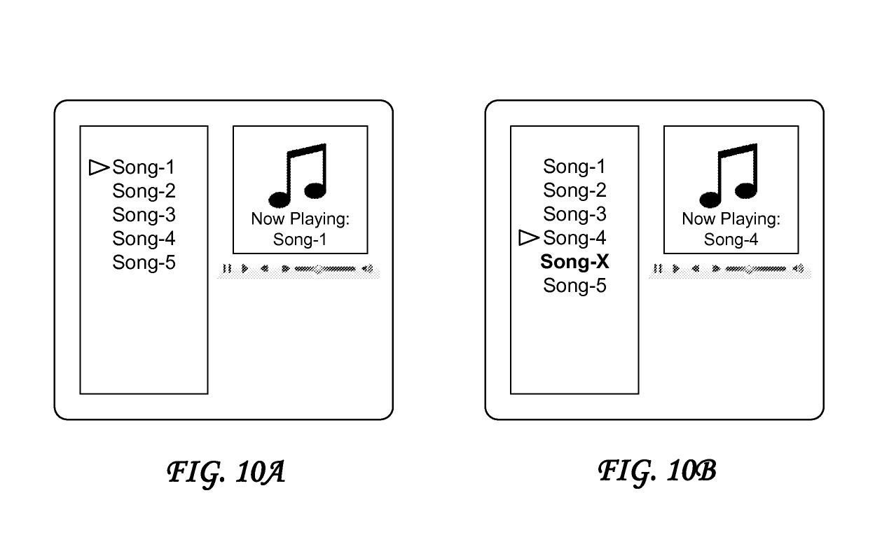

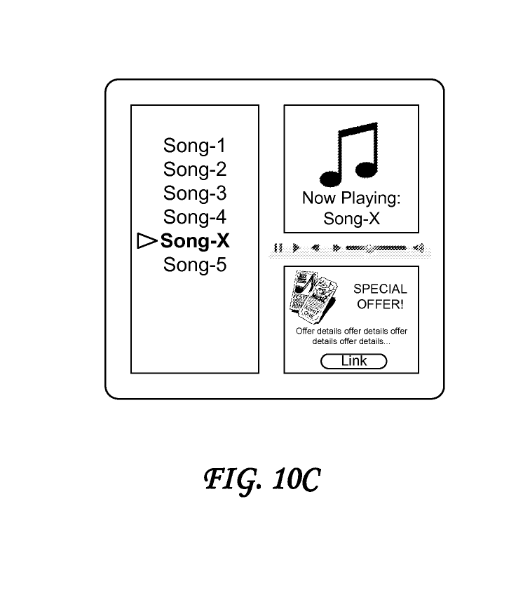

FIGS. 10A, 10B, and 10C illustrate a user interface which may allow a user to access a push recommendation. The user interface may be displayed in a music player application on a device of the user. In FIG. 10A, the user is using a music player application to listen to music. The user may be listening to music using a play queue or a playlist. The play queue or playlist may include multiple songs to be played out (e.g., Song-1, Song-2, . . . Song-5 as illustrated in the figure). At the point in time illustrated in FIG. 10A, the user may be listening to Song-1.

The music player application, the service provider, and a third party recommender may interact to generate a push recommendation as previously described. FIG. 10B illustrates the user interface at a point in time after the third party recommender has injected a recommended song (“Song-X”) into the play queue or playlist of the user. At this point, the recommended song is visible in the list of songs to be played, and the user may be aware that the recommended song will be played. The third party recommender may have provided additional metadata to describe an offer or advertisement associated with the recommended song, and such additional metadata may be available to the music player application and/or the service provider. The offer or advertisement may not be displayed in the user interface at the time associated with FIG. 10B, as the recommended song is not currently playing at this time.

FIG. 10C illustrates the user interface at a point in time where the user is listening to the recommended song. As illustrated in the figure, the music player application and/or the service provider may display the offer or advertisement associated with the recommended song while the recommended song is playing. The user may examine the offer or advertisement while listening to the recommended song, and may interact with the offer or advertisement via an active link embedded in the offer or advertisement. For example, pushing the link may cause the music player application to pop up a window which has additional details of an offer, or it may direct a web browser to a location associated with the offer. In this way, the user may act on an offer associated with a recommended song injected into the user's play queue or into a playlist of the user. For example, the user may purchase concert tickets, movie tickets, a live version of a song, a CD, etc.

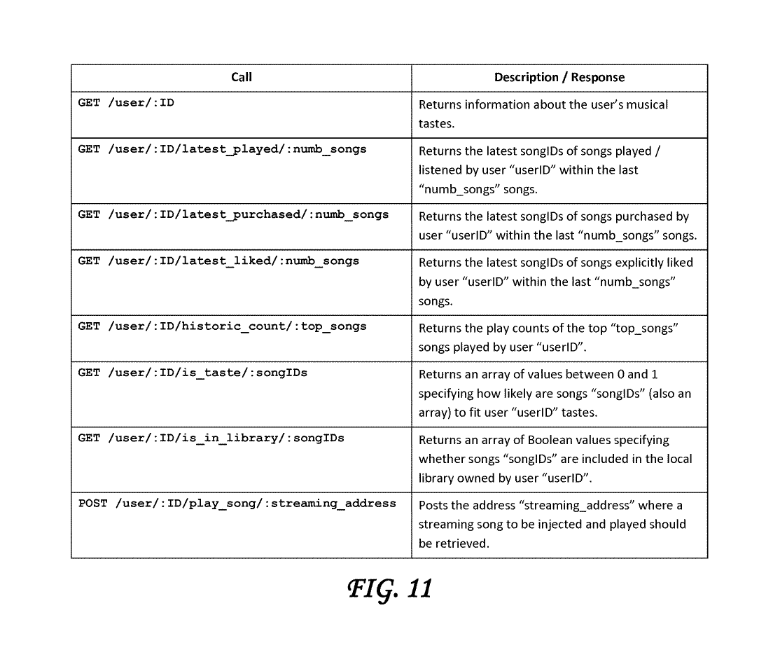

FIG. 11 is a diagram of an example of Application Programming Interface (API) calls and responses for playing a recommended song. Examples of Representational State Transfer (REST)-based API calls and associated responses that may achieve some of the cross-platform functionalities described are illustrated. A hierarchical RESTful call structure may be assumed, with this example focusing on API calls relating to audio content (i.e., music), although a similar structure may be used for any other media content. In one or more examples, other languages, including Java, and structures may be used for calls, for example, in addition to REST-based APIs.

The push of media content from an outside service may be achieved with the POST call, where a streaming address is passed to the service the user is playing content from (“current service”). The current service may retrieve the content and inject it into the user's playlist automatically and without the user's intervention.

Metadata specifying the content to be injected may be pushed from another service provider to the current service. The current service may then retrieve the content either locally or from other streaming services and inject it into the user's playlist.

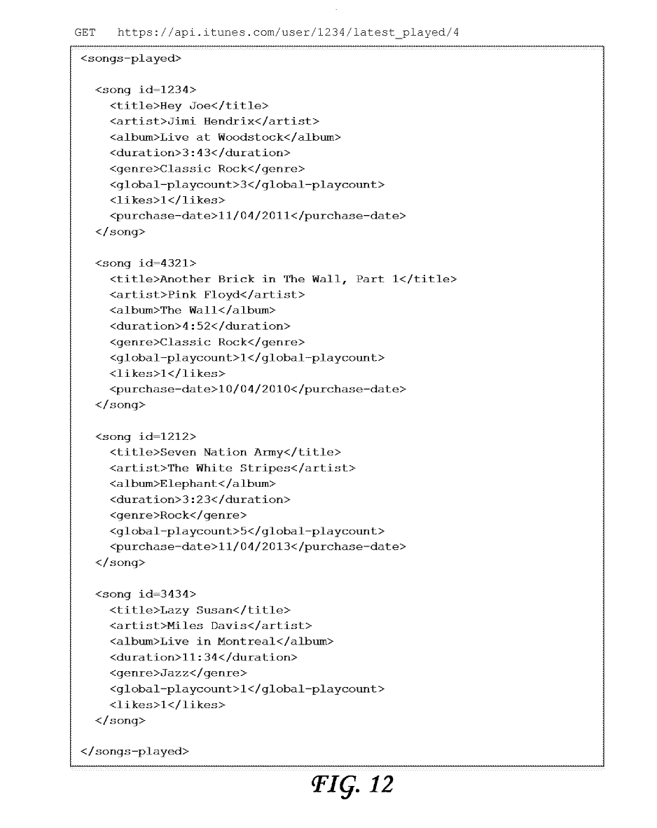

FIG. 12 is a diagram of an example of a request to determine the most recent songs played.

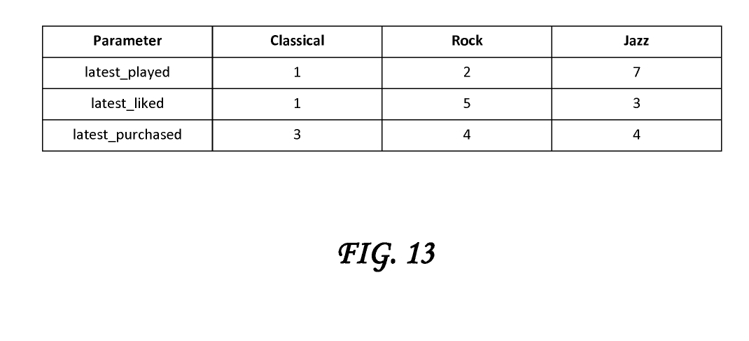

Turning to FIG. 13, a diagram of an example of a table built while determining user preferences will be described. In one example, a user gives a personalized streaming service provider (such as Spotify™, for example) access to his other music services, including a service provider for user-owned songs (such as iTunes™) and another personalized streaming service provider (such as Pandora™). Accordingly, the personalized streaming service provider may use the user's “userID” and password to access those services and retrieve information about the user's preferences and musical tastes. The service provider for user-owned songs may mine the user's user-owned library to gather information about the user's preferences. For example, the user may open iTunes™, select a playlist, and start playing songs from the playlist. iTunes™ may gather information about play counts of songs being played by the user. Spotify™ may query iTunes™ and Pandora™ to gather information about the user's preferences. For example, Spotify™ may request information about the latest 10 songs the user liked and purchased through two calls to each service:

| | |
|---|---|
| GET | https://api.itunes.com/user/1234/latest_liked/10 |
| GET | https://api.itunes.com/user/1234/latest_purchased/10 |
| GET | https://api.pandora.com/user/1234/latest_liked/10 |
| GET | https://api.pandora.com/user/1234/latest_purchased/10 |

Since the user is currently listening to music using iTunes™, Spotify™ may request from iTunes™ the latest 10 songs played by the user with the following call:
GET https://api.itunes.com/user/1234/latest_played/10
   Assuming only three musical genres exist, namely: “Classical,” “Rock,” and “Jazz,” the example table of FIG. 13 may be built. The musical genre that is likely enjoyed by the user at present time may be determined, such as by a weighted linear combination of the above parameters.

For example, a weighted linear combination of the above parameters may include:

GENRE=argmax_{nε{Classical,Rock,Jazz}}Λₙ (Equation 1)

where

Λₙ [symbol] Σ_{iεParameter}wᵢλᵢ⁽ⁿ⁾ (Equation 2)

The terms wᵢ assign specific weights to each numerical parameter λᵢ⁽ⁿ), where

λₗₐₜₑₛₜ_{_}_{played}^{(Classical)}=1,λₗₐₜₑₛₜ_{_}_{played}^{(Rock)}=2,λₗₐₜₑₛₜ_{_}_{played}^{(Jazz)}=7,λₗₐₜₑₛₜ_{_}_{liked}^{(Classical)}=1,etc.

For this example, assume wₗₐₜₑₛₜ_{_}_{played}=0.6; wₗₐₜₑₛₜ_{_}_{liked}=0.2; wₗₐₜₑₛₜ_{_}_{purchased}=0.2; hence more weight is placed onto recently played songs.

Therefore,

Λ_{Classical}=0.6×1+0.2×1+0.2×3=1.4

Λ_{Rock}=0.6×2+0.2×5+0.2×4=3.0

Λ_{Jazz}=0.6×7+0.2×3+0.2×4=5.6

Accordingly, GENRE=argma{Λ_{Classical}, Λ_{Rock}, Λ_{Jazz}}=Jazz.

A jazz song is then selected from a streaming service, pushed to iTunes™ with the following call:
POST https://api.itunes.com/user/1234/play_song/:streaming_address

iTunes™ may inject the song in the playlist (e.g., automatically, without user involvement) and play it between user-owned songs. The user may be given the option to purchase the jazz song. If the user purchases the jazz song, the parameter “latest_purchased” may be updated in the table of FIG. 13.

Other mechanisms and algorithms, linear or non-linear, may be used to identify a song to be injected and played. More importance may be given to certain parameters. The latest play counts may be used as the sole parameter. The selection may be based on the user context.

In an example of a method described herein, a user may connect to a music service. The music service may be a client on the user's device or a streaming music service. The user's playlist (or current song) may be visible to a service provider. The playlist may be user-generated or generated by a music service (for example, music may be locally stored, grabbed from user's cloud locker, streamed from the service, etc).

The service provider may offer (e.g., real-time) an insertion opportunity to a third party (for example, a movie studio, a music label, a local club, theater, etc.). The third party may query for (or may receive) current information about the user (or more generally, about multiple users currently using the music service). Information may indicate one or more of a type of music or specific songs the user is currently listening to, listening history, or demographic info about user. The third party may request the service provider to play a particular song to the current user, based on the current information about the user. The third party may provide the particular song to the service provider (for example, a movie studio may provide a theme song or featured song from a new movie release, a local club may provide a song recorded live the night before at the club, etc.). The third Party may request (may also request) an ad (e.g., a visual ad) to be displayed while the particular song is played (for example, a movie studio may provide an ad about the associated movie and link to buy tickets, a local club may provide an ad showing who is playing the club tonight and a link to buy tickets, etc.).

The service provider may inject the particular song into the user's listening experience (e.g., into the user's current playlist/queue), in response to the request from the third party. If an ad display was requested, the service provider may cause the user's music client to display the ad while the particular song is playing.

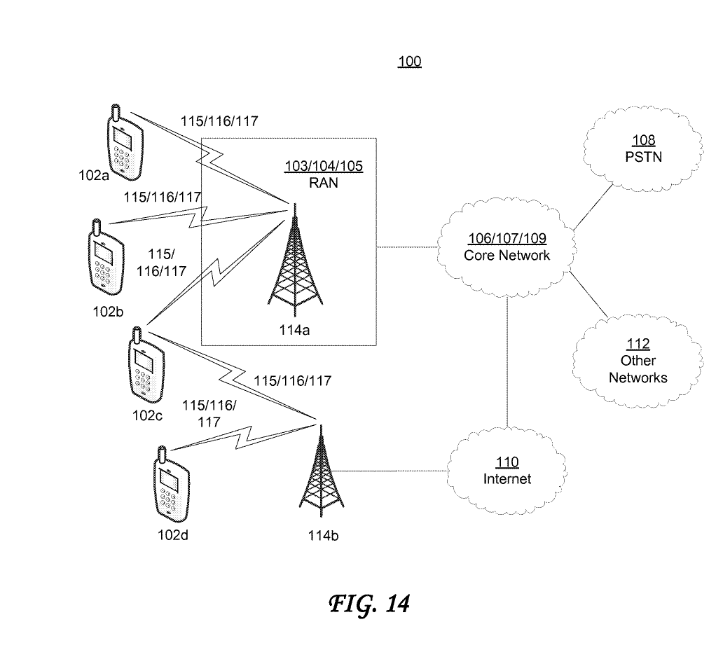

FIG. 14 is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 14, the communications system 100 may include wireless transmit/receive units (WTRUs) 102a, 102b, 102c, 102d, a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, or any other terminal capable of receiving and processing compressed video communications.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 14 may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 14, the base station 114b may have a direct connection to the Internet 110. Thus, the base station 114b may not be required to access the Internet 110 via the core network 106/107/109.

The RAN 103/104/105 may be in communication with the core network 106, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 14, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 14 may be configured to communicate with the base station 114a, which may employ a cellular-based radio technology, and with the base station 114b, which may employ an IEEE 802 radio technology.

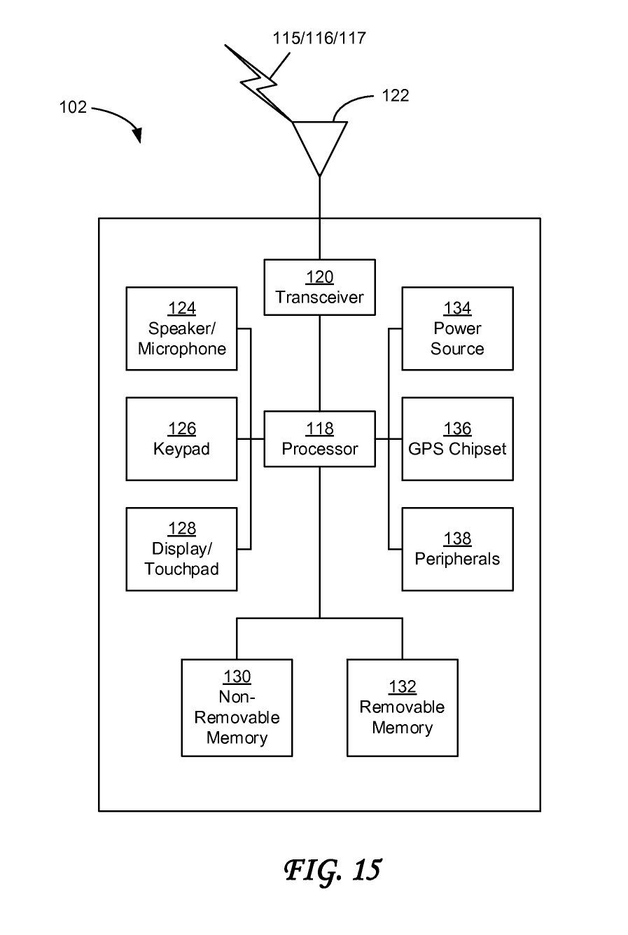

FIG. 15 is a system diagram of an example WTRU 102. As shown in FIG. 15, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 15 and described herein.

The processor 118 may be a general purpose processor, a special purpose processor, a conventional processor, a digital signal processor (DSP), a graphics processing unit (GPU), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 15 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 15 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

1. A method, comprising:
determining that a user is playing a playlist using a primary music service provider on a wireless device;
offering an insertion opportunity to a third party;
receiving a request from the third party to insert a media content into the playlist, wherein the media content is a song that is not part of the playlist; and
injecting the media content into the playlist without the user's intervention.

2. The method of claim 1, wherein selection of the injected media content is performed by the third party.

3. The method of claim 1, wherein the playlist includes one or more media files stored locally on the wireless device.

4. The method of claim 1, further comprising receiving the injected media content from the third party.

5. The method of claim 1, wherein the insertion opportunity includes information about the user.

6. The method of claim 5, wherein information about the user comprises the user's taste, content liked, or latest media file played.

7. The method of claim 1, further comprising requesting information from the user about the media content injected into the playlist.

8. The method of claim 7, further comprising storing the user's response about the media content to build a profile about the user's preferences.

9. The method of claim 8, further comprising using the user profile to refine another insertion opportunity.

10. The method of claim 1, receiving a request from the third party for information about the user, and responding to the request.

11. The method of claim 1, wherein the injected media content relates to associated services provided by the third party.

12. The method of claim 11, wherein the associated services include promoting media file sales, live music venues, theaters, or motion picture productions.

13. A server, comprising:
a processor configured to:
determine that a user is playing a playlist on a wireless device;
offer an insertion opportunity to a third party;
receive a realest from the third party for information about the user's tastes and preferences:
respond to the request;
receive a request from the third party to insert a media content into the playlist, wherein the media content is a song that is not part of the playlist and wherein selection of the song is performed by the third party; and
inject the media content into the playlist without the user's intervention.

14. (canceled)

15. The server of claim 13, wherein the playlist includes one or more media files stored locally on the wireless device.

16. The server of claim 13, further comprising wherein the processor is configured to receive the media content from the third party.

17. The server of claim 13, wherein the insertion opportunity includes information about the user.

18. The server of claim 17, wherein information about the user comprises the user's taste, latest media content liked, or latest media file played.

19. The server of claim 13, further comprising wherein the processor is configured to request information from the user about the media content injected into the playlist.

20. The server of claim 13, further comprising wherein the processor is configured to store the user's response about the media content to build a profile about the user's preferences.

21. The server of claim 20, further comprising wherein the processor is configured to use the user profile to refine another insertion opportunity.

22. (canceled)

23. The server of claim 13, wherein the injected media content relates to associated services provided by the third party.

24. The server of claim 23, wherein the associated services include promoting media file sales, live music venues, theaters, or motion picture productions.

25. A method, comprising:
receiving an insertion opportunity message:
receiving information about a user playing a playlist from a music streaming service provider on a wireless device;
determining, based on the information, a media content for the user, wherein the media content is a song that is not part of the playlist; and
requesting Rail the music streaming, service provider to inject the media content into the playlist, without the user's intervention.

26.-27. (canceled)

28. The method of 25, wherein the playlist is from a library of media files belonging to the user.

29. The method of 28, wherein the user's library of media files is locally stored on the wireless device.

30. The method of 28, wherein the user's library of media files is stored in a cloud storage.

31. The method of claim 28, wherein the media file is a song or a song and a video, and the media content is a song or a song and a video that is not from the library of media files belonging to the user.

32. The method of claim 25, further comprising receiving user feedback about the media content.

33. The method of claim 25, further comprising requesting an offer or advertisement be displayed when the media content is played, wherein the media content and the offer or advertisement relate to associated services.

34. The method of claim 33, wherein the associated services include promoting media file sales, live music venues, theaters, or motion picture productions.
